(19) United States
(12) Patent Application Publication
(10) Pub. No.: US 2007/0068012 A1
(43) Pub. Date: Mar. 29, 2007

(54) Reciprocating saw

(75) Inventor: Yasheng Chen, Nanjing (CN)

Correspondence Address: WALLENSTEIN & WAGNER, LTD., 311 SOUTH WACKER DRIVE, 53RD FLOOR, CHICAGO, IL, 60606, US

(73) Assignee: Nanjing Chervon Industry Co., Ltd.

(21) Appl. No.: 11/528,918

(22) Filed: Sep. 28, 2006

(30) Foreign Application Priority Data
Sep. 29, 2005 (CN) 200520076226.6

(51) Int. Cl. B23D 49/00

(52) U.S. Cl. 30/392

(57) ABSTRACT

A reciprocating saw of the present invention compromises: a main handle, two side shells, a base plate, a saw blade, and further comprises an auxiliary handle. The auxiliary handle is detachably installed to one of the side shells, and forms a predetermined angle therebetween. Accordingly, an operator can hold the main handle with one hand and hold the auxiliary handle with the other hand during cutting, such that it is much easier to keep balance, and makes the cutting more accurate and comfortable. The reciprocating saw disclosed in the present invention solves previous problems by allowing for steady operation and more control over cutting direction accuracy. It also provides more comfortable gradient cutting.

### CROSS-REFERENCE TO RELATED APPLICATIONS

This application claims priority to Chinese Application No. 200520076226.6 filed Sep. 29, 2005, the entire disclosure of which is incorporated herein by reference. Priority to this application is claimed under 35 U.S.C. 119, 120 and/or 365.

### TECHNICAL FIELD

The present invention relates to a reciprocating saw, especially a jigsaw, which provides an auxiliary handle such that an operator can operate the reciprocating saw with both hands.

### BACKGROUND OF THE INVENTION

As a portable and powerful cutting tool, reciprocating saws are widely used in various fields. Typically, a reciprocating saw includes a handle for an operator to grasp. This handle is generally located on the upper portion of the housing. During the operation of the saw, a proper force is exerted on the handle, downwards towards the bottom of the housing. This ensures that the base plate of the saw will firmly attach to the workpiece during operation, such that vibrations and movement off of the desired work direction are reduced. Meanwhile, a forward force should be exerted to control the cutting direction. However, as to a reciprocating saw, there is a common problem. Under the bevel cutting mode, the handle is inclined with the housing beyond the plane of gravity. This makes it difficult for an operator to exert enough force on the base when grasping the handle, so high cutting precision is difficult to achieve. Sometimes the saw cannot even be operated. For such reasons, some operators will use the other hand to hold on to one side of the housing to keep balance. However, there are disadvantages to operating this way. First, the heat and vibrations produced by operating the motor are transferred to the housing, so it is difficult and uncomfortable for an operator to hold on to the housing. Second, it will be difficult to control the cutting direction, especially when cutting at an angle to the workpiece. Actually, even during normal vertical cutting, similar disadvantages arise due to operating with only one hand grasping the handle on the top of the tool housing. For example, it is not easy to control the cutting direction, and operators will soon get tired. Aforesaid disadvantages commonly exist in the present reciprocating saws, and have not been solved till now.

### SUMMARY OF THE INVENTION

The purpose of the present invention to provide a reciprocating saw, which can be operated easily and steadily, and the cutting direction can be well controlled.

To achieve this objective, the reciprocating saw of the present invention includes a main handle, two side shells, a base plate and a saw blade, and further comprises an auxiliary handle, which is detachably installed to one of the side shells, the auxiliary handle and the side shell forming a predetermined angle.

As a result of the adding of the auxiliary handle, the operator can hold the main handle with one hand and hold the auxiliary handle with the other hand during the cutting. This will make it much easier to keep balance and to achieve high cutting precision. It will also make it much more comfortable to operate.

In another form, the present invention provides at least one connecting device respectively on both side shells for fixing the auxiliary handle. An operator can install the auxiliary handle to either side shells for left-handed or right-handed operation.

In yet another form, the present invention provides two or more connecting devices, on at least one side shell, for the auxiliary handle to be selectively installed with different predetermined angles. So even when the saw is beveled with different angles or being operated under different situations, comfortable grasping can always be attained.

In the fourth form of the present invention, when the auxiliary handle is installed in one of the side shells, the vertical or horizontal angle between the auxiliary handle and the side shell can be adjusted and fixed on any needed angles. So an operator can adjust the angle and direction of the auxiliary handle to optimize the best grasping position.

In the fifth form of the present invention, the auxiliary handle can be connected to a storage assembly which is at the tail portion of the reciprocating saw. In this position, the auxiliary handle will be approximately parallel to a longitudinal axis of the saw. When it is not necessary to use the auxiliary handle, it can be fixed to the storage assembly such that cutting will not be affected.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

Advantages and novel features of the present invention will become apparent from the following detailed description of the preferred embodiment of the invention illustrated in the accompanying drawings, wherein:

FIG. 1 is a sketch map of an reciprocating saw of the present invention, wherein the saw is being beveled.

FIG. 2 is a front view of an embodiment of the present invention;

FIG. 3 is front view of another embodiment of the present invention; and,

FIG. 4 is front view of the third embodiment of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

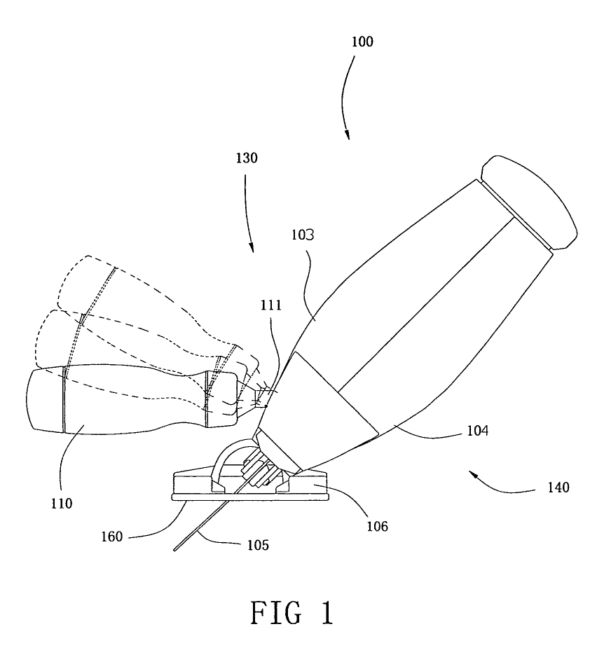

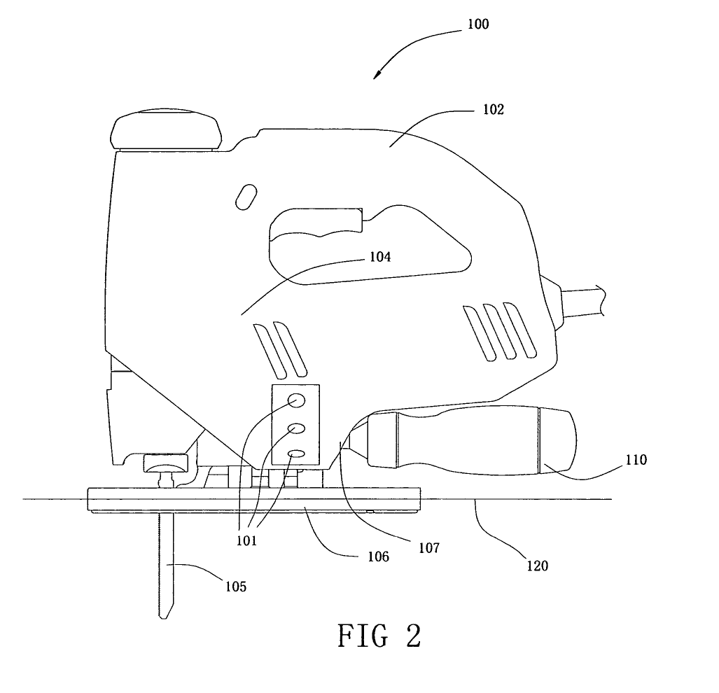

Referring to FIGS. 1-2, a reciprocating saw 100 comprises a main handle 102, a first and a second side shell 103,104 forming a housing, a saw blade 105 for reciprocatingly cutting under driven of a motor (not shown), a base plate 106 with a bottom plane 160, a longitudinal axis 120 running through the central of the reciprocating saw and divides the housing and base plate into a first side portion and a second side portion; and further comprises an auxiliary handle 110, which includes a connecting end 111. In the present embodiment, the connecting end 111 is a screw pin. There is a connecting device 101 on one of the first side shell 103 and the second side shell 104. In the present embodiment, the connecting device 101 is a threaded hole matching to said screw pin. Obviously, to connect by threaded means is just one of the numerous embodiments, the connecting end 111 and the connecting device 101 are not limited to said structure. Any other structures that would be obvious to persons skilled in present art are also applicable.

The auxiliary handle 110 is fixed to one of the first and second side shells 103, 104 by engagement between the connecting device 101 and the connecting end 111. Preferredly the present invention provides connecting devices 101 on both of the first side shell 103 and the second side shell 104. So the auxiliary handle 110 can be installed on either the first side shell 103 or the second side shell 104 to satisfy different users' need.

Referring to FIG. 2, there is a storage assembly (not shown in the drawings) at the tail portion 107 of the reciprocating saw 100. In the present embodiment, the storage assembly is a threaded hole. The connecting end 111 can be engaged to the storage assembly, such that the auxiliary handle 110 is fixed to the tail portion 107, and is approximately parallel to a longitudinal axis of the saw 100. When it is not necessary to use the auxiliary handle, it can be fixed to the storage assembly such that cutting will not be affected.

Referring to FIG. 2, there are more than two connecting devices 101 on the second side shell 104 (there may also be more than two connecting devices 101 on the first side shell 103). The threaded holes of the connecting devices 101 have different angles and directions, so when the auxiliary handle 110 connects to the threaded holes, different angles will be formed between the auxiliary handle 110 and the side shell 103, 104, referring to FIG. 1. When a different bevel angle is needed, different connecting devices 101 can be selected to make the angle between the auxiliary handle 110 and side shell 103, 104 suitable to operate.

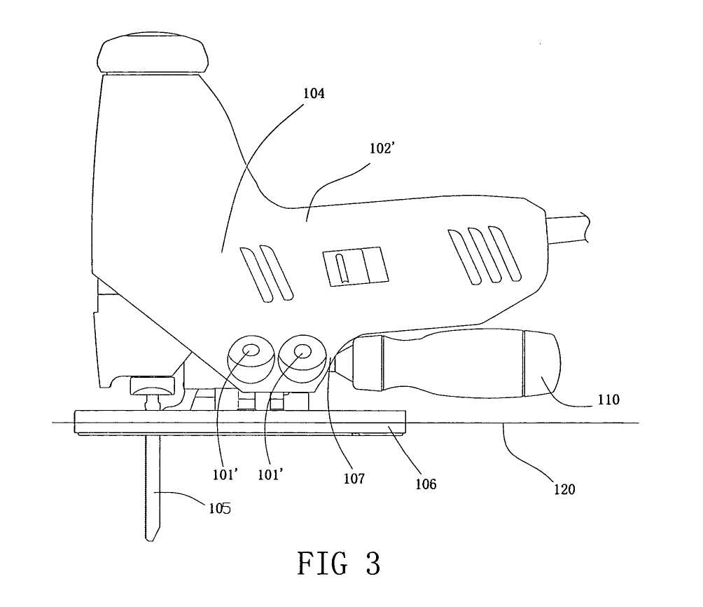

FIG. 3 shows another embodiment of the present invention. Wherein the main handle 102′ lies on the top of the first side shell 103 and the second side shell 104. Different connecting devices 101′ are transversely arranged.

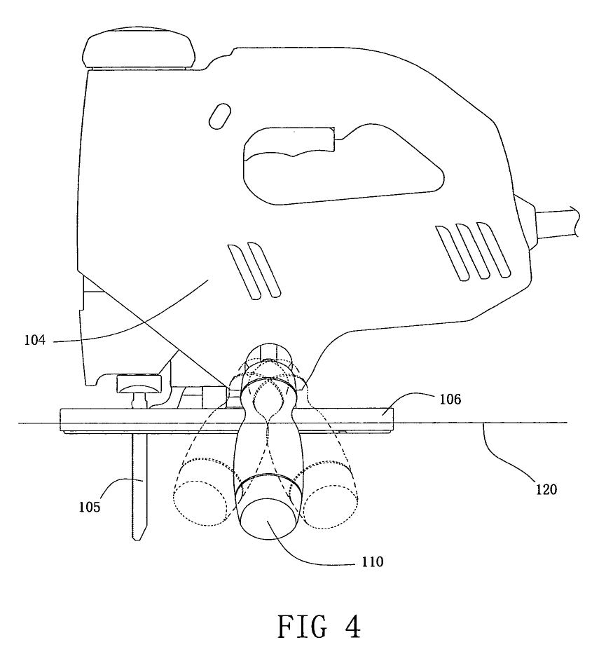

As a further supplement to the embodiments set forth above, when the auxiliary handle 110 is installed to one of the side shells 103, 104 the vertical angle between the auxiliary handle 110 and the side shell 103, 104 can be adjusted directly. The auxiliary handle 110 does not have to be detached from one connecting device 101 and then installed to the other to change the angle and direction as that has been disclosed in FIGS. 2, 3. The connecting device 101 can be a universal connector, such that the horizontal angle between the auxiliary handle 110 and the side shell 103, 104 can also be adjusted directly, referring to FIG. 4. The auxiliary handle can also be fixed at a certain angle with a screw or other means (not shown in the drawings).

As a further embodiment of the present invention (not shown), a connecting device is provided on one side or each side of the base plate such that the auxiliary handle can selectively and detachably mount to one side of the base plate. The connecting device can be a screw threaded hole. And the auxiliary handle comprises a screw pin which can be received in and engaged with the screw threaded hole on the base plate. When the auxiliary handle is fixed to the base plate, a predetermined angle is formed between a central axis of the auxiliary handle and bottom plane of the base plate. Since the base plate will not incline with housing of the saw during a bevel cutting, the auxiliary handle can always be on its best position for an operator to hold on what ever angle the saw inclined under bevel cutting mode.

While the specific embodiments have been illustrated and described, numerous modifications come to mind without significantly departing from the spirit of the invention, and the scope of protection is only limited by the scope of the accompanying Claims.

What is claimed is:

1. A reciprocating saw, comprising: a main handle, two side shells, a base plate and a saw blade, the reciprocating saw further compromising an auxiliary handle, the auxiliary handle detachably connected to one of the side shells, the auxiliary handle and the side shell which it is installed to forming a predetermined angle.

2. The reciprocating saw of claim 1, wherein each of the two side shells comprises at least one connecting device for connecting to the auxiliary handle.

3. The reciprocating saw of claim 1, wherein at least one of the side shells comprise two or more connecting devices for connecting to the auxiliary handle, the auxiliary handle forming different angles with the side shell when installed to the different connecting devices.

4. The reciprocating saw of claim 1 further comprising a storage assembly at a tail portion for storing the auxiliary handle, the auxiliary handle approximately parallel to a longitudinal axis of the reciprocating saw when connected to the storage assembly.

5. A reciprocating saw, comprising: a main handle, two side shells, a base plate and a saw blade, wherein each of the side shells has at least one connecting member, the reciprocating saw further comprising an auxiliary handle detachably connected to one of the side shells to form a desired angle.

6. The reciprocating saw of claim 5, wherein each of the two side shells comprises two or more connecting members for connecting the auxiliary handle to the side shell.

7. The reciprocating saw of claim 6, wherein the connecting member is a threaded hole.

8. The reciprocating saw of claim 7, wherein the auxiliary handle includes a connecting end.

9. The reciprocating saw of claim 8, wherein the connecting end is a screw pin, the screw pin matching up with the threaded hole in the side shell.

10. The reciprocating saw of claim 5, wherein the connecting members are arranged transversely on each of the two side shells.

11. The reciprocating saw of claim 5, wherein the desired angle between the auxiliary handle and the side shell can be adjusted by selecting a different connecting member on which to connect the auxiliary handle.

12. The reciprocating saw of claim 5, wherein the reciprocating saw further comprises a storage assembly, the storage assembly proximate a tail portion of the reciprocating saw.

13. The reciprocating saw of claim 12, wherein the storage assembly is a threaded hole.

14. The reciprocating saw of claim 13, wherein the connecting end of the auxiliary handle can be engaged to the storage assembly, such that the auxiliary handle is fixed to the tail portion.

15. A reciprocating saw, comprising: a housing, a motor being contained in the housing for reciprocatingly driving a saw blade for cutting, a base plate with a bottom plane, a longitudinal axis running through the central of the reciprocating saw, and an auxiliary handle, wherein the longitudinal axis divides the housing and the base plate into a first side portion and a second side portion, the auxiliary handle detachably connected to one of the first side portion and the second side portion to form an first angle with the bottom plane and a second angle with the housing.

16. The reciprocating saw of claim 15, wherein the first angle and the second angle are predetermined.

17. The reciprocating saw of claim 15, wherein at least one of the first side portion and the second side portion includes at least one connecting member for connecting the auxiliary handle to the side shell.

18. The reciprocating saw of claim 17, wherein the connecting member is a universal connector, such that the first and the second angles can both be directly adjusted without detaching the auxiliary handle.
